(19) United States
(12) Patent Application Publication
(10) Pub. No.: US 2009/0110453 A1
(43) Pub. Date: Apr. 30, 2009

(54) FUSER MEMBER WITH NANO-SIZED FILLER

(75) Inventors: Alan Richard Kuntz, Webster, NY (US); Patrick James Finn, Webster, NY (US); Richard P. Carney, Webster, NY (US)

Correspondence Address: FAY SHARPE / XEROX - ROCHESTER, 1228 EUCLID AVENUE, 5TH FLOOR, THE HALLE BUILDING, CLEVELAND, OH, 44115, US

(73) Assignee: XEROX CORPORATION

(21) Appl. No.: 11/923,866

(22) Filed: Oct. 25, 2007

(51) Int. Cl. G03G 15/20

(52) U.S. Cl. 399/333

(57) ABSTRACT

A fuser member suited to use in a fusing apparatus of an electrostatographic image rendering device includes a substrate and an outer layer over the substrate. The outer layer includes a matrix material and filler particles dispersed in the matrix material. an outer layer comprising a halopolymer and filler particles. The filler particles have a particle size of less than about 1 micrometer and a particle hardness of greater than about 3 on a Mohs hardness scale and form no more than about 3 percent by volume of the outer layer. The outer layer comprising filler particles nonetheless may provide improved wear of the fuser member.

### CROSS REFERENCE TO RELATED PATENTS AND APPLICATIONS

The following copending application, the disclosure of which is incorporated herein in its entirety by reference, is mentioned:

Application Ser. No. 11/644,624 (Atty Docket No. 20060810-US-NP), filed Dec. 22, 2006 entitled FUSER MEMBER WITH DIAMOND FILLER, by Alan Kuntz, et al.

### BACKGROUND

The exemplary embodiment relates to fuser members. It finds particular application in connection with a fuser member with a release layer which includes a halopolymer, such as a fluoroelastomer, having nano-sized particles distributed therein.

In a typical xerographic printing device, such as a copier or printer, a photoconductive insulating member is charged to a uniform potential and thereafter exposed to a light image of an original document to be reproduced. The exposure discharges the photoconductive insulating surface in exposed or background areas and creates an electrostatic latent image on the member, which corresponds to the image areas contained within the document. Subsequently, the electrostatic latent image on the photoconductive insulating surface is made visible by developing the image with a developing material. Generally, the developing material comprises toner particles adhering triboelectrically to carrier granules. The developed image is subsequently transferred to a print medium, such as a sheet of paper. The fusing of the toner onto the paper is generally accomplished by applying heat to the toner with a heated fuser member and application of pressure.

Fuser members in the form of a roll or belt often have an outer layer or release layer formed of a conformable material which is compatible with the high temperatures employed in fusing. Exemplary coatings for forming the release layer include halopolymers, such as polytetrafluoroethylene, fluorinated ethylene propylene copolymers, fluorosilicone rubbers, fluoroelastomers, and the like. To ensure and maintain good release properties of the fuser member, it has become customary to apply release agents to the fuser member during the fusing operation. Typically, these materials are applied as thin films of, for example, silicone oils to minimize toner offset.

Over time, fuser members coated with, for example, a fluoroelastomer, tend to yield copies which have noticeable print defects, such as gloss variations, due to uneven wear of the coating. In particular, edgewear results from the use of paper of a particular size over an extended period. The portion of the fuser member outside the paper area wears at a different rate from that inside. When paper of a different size is used, an imprint of the size of the original paper tends to appear on the fused sheets. Some extension of the life of a fuser roll has been achieved in the past by distributing the wear. For example, improved wear life of the fuser roll has been achieved by moving the paper edge or accessories relative to the rollers, using very low loading force on sensors and fingers in contact with the surfaces, and using retractable members such as stripper fingers.

A need remains, however, for fuser components for use in electrostatographic machines that have superior mechanical properties. Further, a need remains for fuser coatings having reduced susceptibility to contamination, scratching, and other damage. In addition, a need remains for a fuser component having a longer life. Even further, a need remains for a fuser component that maintains high gloss even as the surface is worn by media or other hardware within the fuser apparatus.

### INCORPORATION BY REFERENCE

The following references, the disclosures of which are incorporated herein in their entireties by reference, are mentioned:

U.S. Pat. No. 5,217,837 describes a multilayered fuser member for fusing thermoplastic resin toner images to a substrate. The fuser member includes a base support member, a thermally conductive silicone elastomer layer, an amino silane primer layer, an adhesive layer, and an elastomer fusing surface comprising poly (vinylidene fluoride-hexafluoropropylene-tetrafluoroethylene). A metal oxide is present in the fusing surface to interact with the polymeric release agent to provide an interfacial barrier layer between the fusing surface and the toner and substantially unreactive with the elastomer.

U.S. Pat. No. 5,595,823 describes a fuser member that includes a core and a layer overlying the core. The layer overlying the core includes a cured fluorocarbon random copolymer with certain fluorinated subunits and a particulate filler that includes aluminum oxide and an alkali metal oxide or hydroxide.

U.S. Pat. No. 5,998,033 describes a fuser member with an outermost layer including a fluoroelastomer with thermally conductive metal oxide fillers and a silane coupling agent that is interactive with the fluoroelastomer and with an optional release agent.

U.S. Pat. No. 6,011,946 is directed to a fuser member having a substrate and a filled polymeric outer layer over the substrate, wherein the filled polymeric outer layer includes a zinc compound dispersed therein. The fuser member also includes a fluid release agent with molecules having amino functionality.

U.S. Pat. No. 6,096,429 is directed to a fuser member having a core and a layer overlying the core wherein the layer overlying the core includes a cured fluorocarbon random copolymer which incorporates a particulate filler that includes zinc oxide, cupric oxide and a material selected from alkali metal oxides and hydroxides. The filler has a total concentration in the layer of 12% to 75% of the total volume of the layer.

U.S. Pat. No. 6,218,014 describes a fuser member comprising a support and coated thereon a fluorocarbon elastomer layer containing a silicon carbide filler and a cupric oxide filler, and/or a silicon carbide filler treated with a silane coupling agent having a reactive functional group. The fuser member further includes a functionalized polydimethylsiloxane release agent applied to the fluorocarbon elastomer layer in an amount sufficient to produce, upon incubation at elevated temperature, a surface having improved toner release properties on said outermost layer.

U.S. Pat. No. 6,582,871 describes a fuser member comprising a base, and a fusing surface layer comprising at least one fluoroelastomer and an Fe₂O₃ filler.

U.S. Pat. No. 6,733,943 describes a fuser component having a substrate, an optional intermediate and/or adhesive layer, and an outer polyimide layer. The outer polyimide layer may include a filler including carbon fillers, metals, metal oxides, doped metal oxides, ceramics, polymer fillers, and nanofillers.

U.S. Pat. No. 6,829,466 describes a fuser component having a layer of high temperature plastic and a low surface energy filler, such as a carbon filler, metal, metal oxide, doped metal oxides, ceramic, polymer filler, or nanofillers.

U.S. Pat. No. 6,838,140 describes a fuser component having a substrate and a silicone rubber layer over the substrate. The silicone rubber layer has a crosslinked product of at least one platinum catalyzed additional curable vinyl terminated polyorganosiloxane, aluminum oxide fillers, iron oxide fillers, cross linking agent, and an optional outer fluoroelastomer layer.

U.S. Pat. No. 6,923,533 describes an imaging apparatus for use in offset printing or inkjet printing apparatuses. An imaging member includes an imaging substrate, and thereover an outer coating comprising a nano-size filler having an average particle size of from about 1 to about 250 nanometers.

U.S. Pat. No. 6,927,006 describes a fuser member having a polyimide substrate, and thereover an outer layer with from about 61 to about 99 volume percent fluorocarbon. A low surface energy filler and/or electrically conducted filler and/or chemically reactive filler may be present in the fluorocarbon outer layer, including carbon fillers, metals, metal oxides, doped metal oxides, ceramics, polymer fillers, and nanofillers, such as boron nitride.

U.S. Pat. No. 6,985,690 discloses polyetherimide-b-polysiloxane block copolymers useful as surface layers for a fuser member in various printing devices, which may be fluorinated or include at least 50% by weight siloxane.

U.S. Pat. No. 7,014,976 discloses a fuser member comprising a core and a pliant coating thereon. The coating comprises a base cushion layer comprised of a first elastomeric composition, with a surface layer thereover which includes a second elastomeric composition. The surface layer includes a particulate silica filler in an amount of about 10 percent by volume or less.

U.S. Published Application No. 2005/0153124 discloses a fluoroelastomer loaded with an inorganic filler which is coupled to the fluoroelastomer by a titanate, zirconate or aluminate for use as a base layer or a release layer on a fuser. The coupled filler bonds tightly to the fluorocarbon matrix, significantly decreasing the wear rate of the member.

U.S. Pub. No. 2006/0263123 discloses a fuser member for fixing a developed image to a copy substrate, comprising: a substrate; and thereover an outer layer comprising a haloelastomer and a deflocculating agent.

U.S. Pub. No. 20060269736 discloses a fuser member for fixing a developed image to a copy substrate. The fuser member includes a substrate and thereover an outer coating comprising a haloelastomer and filler particles, wherein said filler particles have a particle size of less than about 3 microns and a hardness of at least about 3 on the Mohs hardness scale.

### BRIEF DESCRIPTION

In accordance with one aspect of the exemplary embodiment, a fuser member is provided for fixing a developed image to a copy substrate. The fuser member includes a substrate and an outer layer over the substrate. The outer layer includes a halopolymer and filler particles. The filler particles have a particle size of less than 1 micrometer, a hardness of at least 3 on a Mohs hardness scale, and comprise no more than 3 volume percent of the outer layer.

In accordance with another aspect, an image forming apparatus for forming images on a recording medium includes a charge-retentive surface to receive an electrostatic latent image thereon, a development component to apply toner to said charge-retentive surface to develop an electrostatic latent image to form a developed image on said charge-retentive surface, a transfer film component to transfer the developed image from said charge-retentive surface to a copy substrate, and a fusing component for fusing toner images to a surface of said copy substrate. The fusing component includes a substrate and thereover an outer layer comprising a halopolymer and filler particles, wherein said filler particles have a particle size of less than 1 micrometer and a particle hardness of greater than 3 on a Mohs hardness scale, said filler particles comprising no more than 3 volume percent of said outer layer.

In accordance with another aspect, an image rendering device includes an image applying component for applying an image to a copy substrate and a fusing apparatus which receives the copy substrate with the applied image from the image applying component and fixes the applied image more permanently to the copy substrate. The fusing apparatus includes a fusing member and a pressure member which define a nip therebetween for receiving the copy substrate therethrough. At least one of the fuser member and the pressure member includes an outer layer which comprises a matrix material and a particulate filler dispersed therein. The filler particles have a particle size of less than 1 micrometer and a particle hardness of greater than 3 on a Mohs hardness scale. The filler particles comprise no more than 3 volume percent of the outer layer.

In accordance with another aspect, a method of forming a fusing member includes providing a substrate, forming an outer layer over the substrate, the outer layer comprising a halopolymer and filler particles. The filler particles have a particle size of less than 1 micrometer and a particle hardness of greater than 3 on a Mohs hardness scale. The filler particles comprise no more than 3 volume percent of said outer layer.

### BRIEF DESCRIPTION OF THE DRAWINGS

FIG. 1 is a schematic elevational view of an image rendering device in the form of an electrostatographic apparatus which includes a fusing apparatus in accordance with one aspect of the exemplary embodiment;

FIG. 2 is a schematic elevational view of a fusing device suited for use in the image rendering device of FIG. 1, incorporating an exemplary fuser member;

FIG. 3 is a schematic cross sectional view of a portion of a fuser member which includes an outer layer in the form of a coating comprising a nano-sized filler in accordance with one aspect of the exemplary embodiment;

FIG. 4 is a schematic cross sectional view of a portion of a fuser member which includes an outer layer in the form of a coating comprising a nano-sized filler in accordance with another aspect of the exemplary embodiment; and

FIG. 5 is a bar graph showing edgewear for fuser members formed in accordance with the exemplary embodiment and comparative fuser members.

### DETAILED DESCRIPTION

The present exemplary embodiment relates to an image rendering device which includes a fusing apparatus for fixing a developed image on a copy substrate. The fusing apparatus includes a fuser member which comprises a substrate and, thereover, a layer comprising a polymeric material, such as a fluorocarbon polymer, with nano-sized filler particles incorporated therein. In various embodiments, the layer comprising filler particles is the outermost layer of the fuser member. The image rendering device may be a printer, copier, bookbinding machine, or a multifunction device. The exemplary fuser member is suitable for use in electrostatographic, e.g., xerographic, printing processes and is described with particular reference thereto.

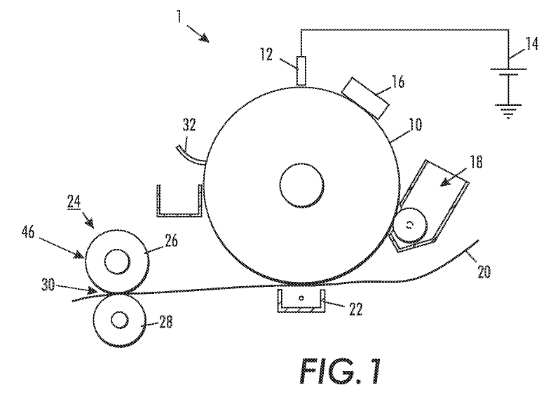

With reference to FIG. 1, in a typical electrostatographic image rendering device, a light image of an original to be copied is recorded in the form of an electrostatic latent image upon a photosensitive member and the latent image is subsequently rendered visible by the application of electroscopic thermoplastic resin particles, which are commonly referred to as toner. Specifically, the illustrated image rendering device includes an image applying component for applying images to a copy substrate, such as a sheet and a fusing apparatus incorporating the exemplary fuser member for fixing, e.g., fusing the images more permanently to the copy substrate. The copy substrate can be a sheet or extended web of paper, plastic, or other generally flexible material.

The illustrated image applying component 1 includes a photoreceptor 10, which is charged on its surface by means of a charger 12 to which a voltage has been supplied from a power supply 14. The photoreceptor is then imagewise exposed to light from an optical system or an image input apparatus 16, such as a laser/light emitting diode, to form an electrostatic latent image thereon. Generally, the electrostatic latent image is developed by bringing a developer mixture comprising toner particles from a developer station 18 into contact therewith. Development can be effected by use of a magnetic brush, powder cloud, or other known development process. Liquid marking materials, such as liquid toners are also contemplated.

After the toner particles have been deposited on the photoconductive surface in an image configuration, they are transferred to a copy sheet 20 by transfer device 22, such as a transfer corotron. Alternatively, the developed image can be transferred to an intermediate transfer member and subsequently transferred to a copy sheet.

After the transfer of the developed image is completed, copy sheet 20 advances to a fusing apparatus 24. The fusing apparatus is depicted in FIG. 1 as including rolls 26, 28 which, during operation, rotate about a longitudinal axis which is generally perpendicular to the direction of travel of the copy sheet. Rolls 26, 28 serve as a fuser member and a pressure member, respectively, and define a nip 30 therebetween.

The developed image is fused to copy sheet 20 by passing the copy sheet through the nip 30 between the fuser member 26 and pressure member 28, thereby forming a permanent image. Photoreceptor 10, subsequent to transfer, advances to cleaning station 32, wherein any toner left on photoreceptor 10 is cleaned therefrom by use of a blade, brush, or other cleaning apparatus. Although in the fusing apparatus 24, the fusing and pressure members are depicted as rollers 26, 28, the fuser and/or pressure member(s) may also be in the form of belts, sheets, films or other like fusing members.

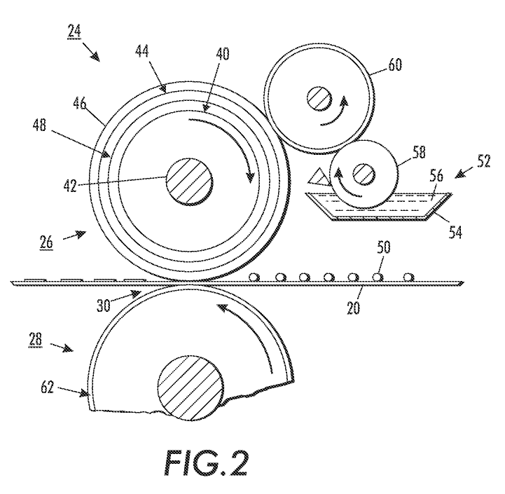

Referring to FIG. 2, the fuser roll 26 includes a substrate which includes a cylindrical hollow member or core 40, fabricated from any suitable rigid material, such as metal, e.g., aluminum, anodized aluminum, steel, nickel, copper, or combination of materials. The core 40 may be heated, generally from within, e.g., by a heating element or elements 42, such as a resistance heater or heat pipe disposed in the hollow portion of the core which is substantially coextensive with the cylinder. However, external heaters are also contemplated. A filler-containing polymer layer 44 disposed over the core 40 and substantially coextensive therewith defines a surface 46. In the illustrated embodiment, layer 44 forms the outermost layer of the fuser member 26. However, it is also contemplated that a further polymer layer (not shown) may be formed on the layer 44 which is substantially coextensive therewith and which may be of substantially smaller thickness than layer 44.

In various embodiments, the fuser member 26 can include an additional layer 48 or layers intermediate the core 40 and the layer 44, which may be in contact with one or both of the core 40 and layer 44 and substantially coextensive therewith. For example, the intermediate layer 48 may comprise one or more of an adhesive layer, a cushion layer, or other suitable layer positioned between core 40 and outer layer 44.

The backup or pressure roll 28 cooperates with fuser roll 26 to form a nip or contact arc 30 through which the copy paper or other substrate 20 passes such that toner images 50 thereon contact the polymer surface 46 of fuser roll 26. In the illustrated embodiment, the fuser roll is a nip-forming fuser roll, i.e., its surface is generally more conformable than that of the pressure roll 28.

In one embodiment, a layer of liquid release agent is delivered to surface 46. For example, a release agent delivery system 52 includes a sump 54 which contains polymeric release agent 56 that may be a solid or liquid at room temperature, but it is a fluid at operating temperatures. In the illustrated embodiment, the fluid 56 is transfer to a rotating pickup roll 58 and thereafter to a rotatable delivery roll 60, which is in contact with the surface 46, although other devices for applying release agent onto the surface 46 are contemplated.

In general, the release agent 56 may be applied in a controlled thickness ranging from less than a micrometer to several micrometers in thickness, e.g., from about 0.1 to about 2 micrometers or greater in thicknesses of release fluid can be applied to the surface of polymer layer 44.

The pressure member 28 may be biased into contact with fuser roll 26 by a compression device, such as a spring or the like. In one embodiment, the pressure roll 28 may include an outer layer 62 of conformable material, such as TEFLON™ or other fluoropolymer over a cylinder of aluminum or similar material, as for substrate 40. In one embodiment, the outer layer 62 of the pressure roll 28 may be configured as for layer 44. However, in general, only the fuser roll 26 has a layer configured as for layer 44. In one embodiment, pressure roll 28 may include a heating element.

The fuser member 26 in accordance with the present exemplary embodiment can be of any suitable configuration. For example, a fuser member may be in the form of sheet, a film, a web, a foil, a strip, a coil, a cylinder, a drum, a roller, an endless strip, a circular disc, a belt including an endless belt, an endless seamed flexible belt, an endless seamless flexible belt, an endless belt having a puzzle cut seam, or the like.

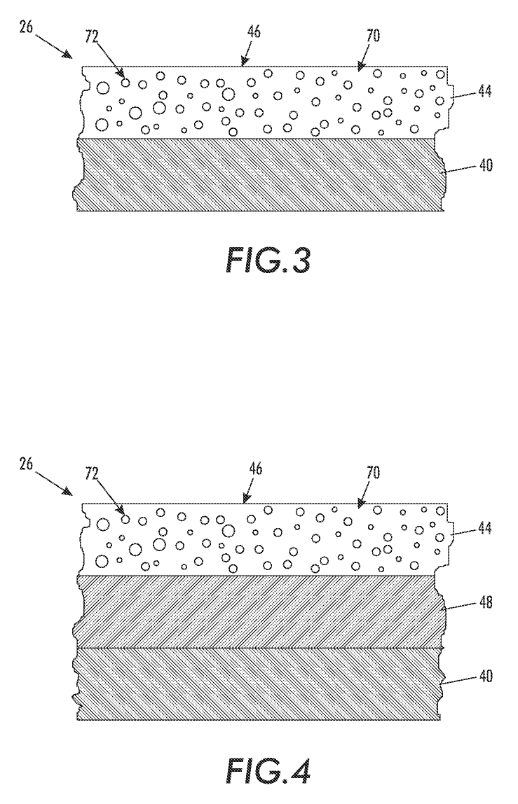

With reference to FIG. 3, the layer 44 includes a polymer matrix 70 in which a filler comprising nano-sized particles 72 (not to scale) is distributed. While FIG. 3 shows the nano-sized particles 72 as being relatively uniformly dispersed throughout the matrix 70, it is also contemplated that non-homogeneous dispersions may be formed, such as a dispersion in which the filler particles are predominantly in a region closer to the surface 46. As will be appreciated, fuser member 26 and layer 44 may be planar, as shown in FIG. 3, or cylindrical, as shown in FIG. 2. It will be further appreciated that a fuser member in accordance with the present disclosure is not limited to the two layer configuration shown in FIG. 3 and that any number of intermediate layers and/or adhesive layers disposed between a substrate and an outer layer are contemplated, as illustrated, for example, in FIG. 4.

Suitable substrates 40 for flexible fuser members, such as belts, include high temperature plastics that are suitable for allowing a high operating temperature (i.e., greater than about 80° C., and generally greater than 200° C.), and capable of exhibiting high mechanical strength. In various aspects, the plastic has a flexural strength of from about 2,000,000 to about 3,000,000 psi, and a flexural modulus of from about 25,000 to about 55,000 psi. Plastics possessing the above characteristics and which are suitable for use as the substrate for the fuser members include epoxy; polyphenylene sulfide such as that sold under the tradenames FORTRON® available from Hoechst Celanese, RYTON R-4® available from Phillips Petroleum, and SUPEC® available from General Electric; polyimides such as polyamideimide sold under the tradename TORLON® 7130 available from Amoco; polyketones such as those sold under the tradename KADEL® E1230 available from Amoco, polyether ether ketone sold under the tradename PEEK 450GL30 from Victrex, polyaryletherketone, and the like; polyamides such as polyphthalamide sold under the tradename AMODEL® available from Amoco; polyethers such as polyethersulfone, polyetherimide, polyaryletherketone, and the like; polyparabanic acid, and the like; liquid crystalline resin (XYDAR®) available from Amoco; ULTEM® available from General Electric; ULTRAPEK® available from BASF; and the like, and mixtures thereof. Other suitable substrate materials include fluoroelastomers such as those sold under the tradename VITON® from DuPont; silicone rubbers, and other elastomeric materials. The substrate may also comprise a mixture of any of the above materials. In embodiments, the substrate comprises aluminum. The substrate as a film, sheet, belt, or the like, may have a thickness of from about 25 to about 250, or from about 60 to about 100 micrometers.

The matrix material 70 of outer layer 44 may comprise a halopolymer, such as a fluorocarbon polymer. In one embodiment, the fluorocarbon polymer is an elastomer. Elastomers are generally crosslinkable materials which deform elastically under pressure and return to their original shape when the pressure is released. An exemplary elastomer is a thermosetting elastomer. Thermosetting elastomers are elastomers which, when they have been cured by heating, cannot be resoftened by subsequent heating. Examples of suitable elastomers which may be derived from halogen-containing monomers include chloroelastomers, fluoroelastomers and the like. Examples of fluoroelastomers include, but are not limited to, ethylenically unsaturated fluoroelastomers, and fluoroelastomers comprising copolymers and terpolymers of vinylidenefluoride, hexafluoropropylene and tetrafluoroethylene. Three known fluoroelastomers are (1) a class of copolymers of vinylidenefluoride, hexafluoropropylene and tetrafluoroethylene, known commercially as VITON A®, (2) a class of terpolymers of vinylidenefluoride, hexafluoropropylene and tetrafluoroethylene known commercially as VITON B®, and (3) a class of tetrapolymers of vinylidenefluoride, hexafluoropropylene, tetrafluoroethylene and a cure site monomer, these polymers including, for example, VITON GF®, VITON A®, and VITON B®. In another embodiment, the fluoroelastomer is a tetrapolymer having a relatively low quantity of vinylidenefluoride.

Exemplary fluoroelastomers comprising copolymers and terpolymers of vinylidenefluoride, hexafluoropropylene and tetrafluoroethylene are available commercially under the designations VITON A®, VITON B®, VITON E®, VITON F®, VITON E60C®, VITON E45®, VITON E430®, VITON B 910®, VITON GH®, VITON B50®, VITON E45®, and VITON GF®. The VITON® designation is a Trademark of E.I. DuPont de Nemours, Inc. Other suitable polymeric materials suitable for forming layer 44 are described, for example, in above-mentioned U.S. Pub Nos. 20060263123 and 20060269736, incorporated herein by reference.

The VITON GF® polymer, for example, has 35 weight percent of vinylidenefluoride, 34 weight percent of hexafluoropropylene and 29 weight percent of tetrafluoroethylene with 2 weight percent cure site monomer.

Typically, fluoroelastomers, such as VITON® are cured with a nucleophilic addition curing system, such as a bisphenol cross-linking agent with an organophosphonium salt accelerator as described in further detail in the above referenced U.S. Pat. Nos. 4,257,699 and 5,017,432. The cure site monomer used in the curing of the exemplary fluoroelastomers can be those available from DuPont such as 4,4′-(Hexafluoroisopropylidene)diphenol (commonly known as bisphenol AF), 4-bromoperfluorobutene-1,1,1-dihydro-4-bromoperfluorobutene-1,3-bromoperfluoropropene-1,1,1-dihydro-3-bromoperfluoropropene-1, or any other suitable, known, commercially available cure site monomer. A specific, non-limiting example of a suitable curing agent is Viton Curative VC50™ (available from United Chemical Technologies, Inc.), which includes an accelerator (such as a quaternary phosphonium salt or salts like VC20) and a cross-linking agent (bisphenol AF or VC30). Other curing agents include, for example, but are not limited to, A0700 curative (N-(2-aminoethyl)-3-aminopropyltrimethoxysilane, available from United Chemical Technologies, Inc.).

The layer 44 may be at least 1 micron in thickness. In various aspects, the layer 44 is at least 5 microns in thickness and in some aspects, at least 15 microns in thickness. In some aspects, the layer 44 is up to about 500 microns in thickness, e.g., up to about 250 microns or up to about 150 microns. In some aspects, the thickness of the outer layer is from about 5 to about 250 microns. In other aspects, the thickness of the outer layer is from about 15 to about 150 microns. In still other aspects, the thickness of the outer layer is from about 20 to about 80 microns.

The layer 44 may include at least 60 volume % of matrix material 70. In one embodiment, the matrix material may make up at least about 80 vol. %, or at least 95 vol. % of the layer 44 and can be up to 99.5 vol. % of layer 44.

In various embodiments, the nano-sized particles 72 may be present in the layer 44 at no more than 3 vol. %. Specifically, the total amount of all particulate filler in layer 44 which has a Mohs hardness of at least 3 constitutes no more than 3 vol. % of layer 44 and all particulate filler present in the layer 44 which has a Mohs hardness of greater than 3 has a particle size of less than 1 micrometer. In specific embodiments, filler 72 is present at about 2 vol. % or less of layer 44, e.g., 1.5 vol. %, or less. The nano-sized filler particles 72 may be at least about 0.1% by volume of the layer 44 and in some embodiments, at least 0.5 vol. % of the layer 44. In one specific embodiment, the nano-sized filler particles 72 may be about 0.5% by volume of the layer 44.

Exemplary filler particles comprise particles of relatively hard, ceramic forming materials, such as aluminum oxide (alumina), silica, boron nitride, aluminum nitride, boron carbide, silicon carbides, tungsten carbide, anatase titanium dioxide, rutile titanium dioxide, zinc oxide, diamond, and combinations thereof. In one embodiment the filler particles are formed primarily of alumina, i.e., comprise greater than 50 weight % alumina, and may be at least 90 wt. or at least 99 wt. % alumina.

In general, the nano-sized filler particles 72 have a particle hardness of at least about 3 on the Mohs hardness scale and in some embodiments, a Mohs hardness of at least 4. In other embodiments, the Mohs hardness is at least 6 and can be up to 10.

The nano-sized filler particles 72 in layer 44 may have a particle size of less than about 1 micrometer. In one specific embodiment, the filler has a particle size of less than about 0.5 micrometers, and in some embodiments, less than 200 nanometers. In still another embodiment, the filler has a particle size of at least 1 nm, e.g., in the range of from about 5 nm to about 100 nm. In still a further embodiment, the filler has a particle size in the range of from about 10 nm to about 80 nm, and in one specific embodiment, no more than about 60 nm.

As used herein, particle size refers to the average size of a characteristic dimension of a filler particle based on the shape of the filler particle(s). Particle size may be determined as a cumulative weight average value D₅₀ (median diameter) by particle size distribution measurement using the laser light diffraction method. The particle size may thus be given in terms of the diameter of substantially spherical particles or nominal diameter for irregular shaped particles. Further, the shape of the filler particles is not limited in any manner.

As will be appreciated, the particle size has a distribution from small to large particles. In the exemplary embodiment, the distribution is selected such that there are very few individual particles which have an individual particle size of greater than 100 nm. The particle size distribution may be selected such that in layer 44, at least 90% of particles 72 (i.e., particles have a Mohs hardness of greater than 3), have an individual particle size of less than 100 nanometers. In some embodiments, at least 95% of particles 72 have an individual particle size of less than 100 nanometers. The particulate material to be incorporated as the filler may have a surface area (as measured by the BET method) of at least 5 m²/g, e.g., from 5-100 m²/g, and in one embodiment, at least 10 m²/g.

If the average size of the particles 72 is too large, the particles tend to interfere with release properties of the layer 44. In the size range of the exemplary embodiment, the particles remain in the matrix and increase the wear resistance of the layer 44. It has been found that alumina is a particularly effective filler when present at small size and fairly evenly distributed though the matrix 70 (or at least in a portion of layer 44 adjacent surface 46).

One exemplary particulate alumina is Nanotek™ Aluminum Oxide, available from Nanophase Technologies Corporation, Romeoville, Ill. 60446. This material is 99.95% pure Al₂O₃. The material has a specific surface area of 35 m²/g (as determined by the BET method), a bulk density of 0.26 g/cc, a true density of 3.6 g/cc. The crystal phase is 70:30 delta:gamma alumina. The particles are substantially spherical and in an approximated manual estimate of the particle size made by examination of photomicrographs of a sonicated sample of the particles obtained using Analytical Transmission Electron Microscopy (ATEM), fewer than 5% of particles had a diameter greater than 100 microns (approximately 2.5%) and the maximum particle diameter observed in the sample of 1014 particles was 189.56 nm.

Without being bound to any particular theory, a fuser comprising an outer layer that includes a halopolymer, such as a fluoroelastomer, and the exemplary filler comprising nano-sized particles improves wear, even at such low levels, while providing a surface with good release properties. As the fuser is worn, the surface remains at a relatively high gloss, and the difference in surface texture between worn and unworn surface areas will be relatively small such that the delta gloss failure modes on the resulting print can be reduced or, in some instances, eliminated. Thus, the use of such outer layers effectively extends the life of the fuser components. Further, the gloss of the worn areas is impacted by particle size, particle hardness and filler concentration. Gloss may, therefore, be adjusted by varying the particle size, shape of particle and/or particle hardness, and/or filler concentration to match the gloss of the roll surface.

In addition to particles 72, layer 44 may comprise particles of other materials such as particles of a softer filler material having a Mohs hardness of less than 3, such as carbon black (Mohs hardness 2-2.9), which may be present in layer 44 at amount of from about 0.1 to about 40 volume %. Other materials may be present in layer 44. In one embodiment, layer 44 includes a deflocculating agent, as described, for example, in U.S. Pub. No. 20060263123, incorporated by reference. Examples of such deflocculating agents include Disperbyk polymer compositions available from BYK Chemie and polymethacrylic acid. The deflocculating agent may be present in an amount of from about 0.1 to about 10 percent by weight of the polymer.

The outer layer 44 composition may optionally comprise a surfactant. Examples of materials suitable for use as a surfactant in an outer layer 44 include, but are not limited to, polymeric fluoro-surfactants such as FC4430, available from 3M Corporation under the designation FLUORAD® FC4430. Exemplary fluorinated surfactants of this type which may be employed are described, for example, in U.S. Pub. No. 20060263533, by Kaplan, et al., incorporated herein by reference in its entirety. In another embodiment, the outer layer is substantially free of a surfactant.

Curatives, such as an alkali metal oxide and/or hydroxide may also be present in layer 44. Exemplary curatives include calcium hydroxide and magnesium oxide, alone or in combination.

In another embodiment of a fuser member, illustrated in FIG. 4, an intermediate layer 48 may be positioned between the substrate 40 and the outer layer 44. Materials suitable for use in the intermediate layer 48 include silicone rubber, elastomers such as fluoroelastomers, fluorosilicones, ethylene propylene diene rubbers, silicone rubbers such as fluorosilicones, phenyl silicones, silicone blends, and the like. Additional polymers useful as the intermediate layer include fluoropolymers such as polytetrafluoroethylene (PTFE), fluorinated ethylenepropylene copolymer (FEP), polyfluoroalkoxy polytetrafluoroethylene (PFA Teflon), ethylene chlorotrifluoro ethylene (ECTFE), ethylene tetrafluoroethylene (ETFE), polytetrafluoroethylene perfluoromethylvinylether copolymer (MFA), and the like. These polymers, together with adhesives, can be included as intermediate layers and the like, and mixtures thereof. In various embodiments, the intermediate layer is conformable and is of a thickness of from about thickness of from about 50 to about 1200 micrometers, or from about 100 to about 650 micrometers.

Examples of suitable adhesives for use as an intermediate layer 48 include silanes, such as amino silanes (such as, for example, A1100 from OSI Specialties, Friendly, W. Va.), titanates, zirconates, aluminates, and the like, and mixtures thereof. In an embodiment, an adhesive in from about 0.25 to about 10 percent solution can be wiped on the substrate 40. The adhesive layer can be coated on the substrate or on another intermediate layer, to a thickness of from about 2 to about 2,000 nanometers, or from about 2 to about 500 nanometers. The adhesive can be coated by any suitable, known technique, including spray coating or wiping.

The substrate 40 and optional intermediate layer(s) 48 may also include fillers dispersed therein. The fillers in the substrate and/or optional intermediate layer(s) are not critical and not limited in any manner, and not limited in terms of particle size or hardness. For example, the substrate and/or optional intermediate layer(s) may include filler particles having a particle size of less than about 3 microns and a particle hardness of at least about 3 on the Mohs hardness scale. Examples of suitable fillers for the substrate and/or optional intermediate layer(s) include those described in U.S. Pat. Nos. 6,829,466 and 6,838,140, incorporated by reference.

In one specific embodiment, a fuser roll formed in accordance with the exemplary embodiment is composed of a silicone rubber intermediate layer 48 over an aluminum core 40 with a topcoat 44 comprised of a thin layer of fluoroelastomer, the functions of which include preventing the fuser oil from swelling the silicone rubber and assisting in releasing toner. The particulate material 72 present in layer 44 reduces wear without substantially interfering with toner release.

The exemplary material comprising a halopolymer with nano-sized filler particles dispersed therein may find application as an intermediate or outermost layer in pressure rolls, belts, blades, and fuser donor rolls.

The coating compositions comprising the halopolymer and filler particles in accordance with the present disclosure may be prepared by milling the halopolymer together with the filler and optionally a curative in a roll mill. The material may then be molded or extruded onto the roll/belt. Alternately, the compounded material may be milled on a roll mill and dissolved in a suitable solvent such as MEK, MIBK, acetone or the like. Alternately, portions of the material are milled on a roll mill and others may be added directly to the solvent. In yet other embodiments, milling of the halopolymer and filler may take place in the solvent, for example, in a pebble mill or Brabender-type mixer. The “dissolved” material is then coated onto the component by spraying, dipping, ring coating or flow coating. Exemplary flow coating methods are described, for example, in U.S. Pat. No. 6,521,330, which is incorporated herein by reference in its entirety.

The following examples are for purposes of further illustrating fuser components in accordance with the present disclosure. The examples are merely illustrative and are not intended to limit fuser components in accordance with the disclosure to the materials, conditions, or process parameters set forth therein.

### EXAMPLES

A coating is prepared as follows. All parts are per hundred (pph) rubber, by volume, unless otherwise indicated. The following ingredients are employed:

| | |
|---|---|
| Viton GF | 100 parts (Dow-DuPont) |
| Filler | 4.6 or 7.3 parts of nano particles, |
| | such as 50 nm alumina particles |
| Ca(OH)₂ | 0.75 parts |
| MgO | 1.5 parts |
| FC4430 (surfactant) | 0.75 parts |
| AKE 290 | 0.25 parts |
| (fluorinated silicone fluid) | |
| VC50 (curative) | 5 parts (Dow-DuPont) |

First, the Viton GF and nano alumina filler are milled in a roll mill. A dispersion is then created by mixing the milled components in MIBK. The dispersion is split into two. The calcium hydroxide and magnesium oxide are milled in a jar mill and added to one half of the dispersion together with the surfactant and fluorinated silicone fluid. VC-50 is added to the other half of the dispersion. Finally, the two halves are brought together, just before applying to a roll, thus forming the coating.

Rolls are formed by flow coating the coating onto a substrate. Alternatively, a coating may be formed by mixing with MEK or MIBK and the coating may be applied to a layer of silicone rubber. The following rolls are prepared:

A: Comparative roll without filler

B: Filled roll formed using the methods described above with 7.3 pph nano alumina particles

C: Filled roll formed using the methods described above with 4.6 pph nano alumina particles

D: Filled roll formed using the methods described above with 4.6 pph nano alumina particles

E: Filled roll formed using methods described above with 7.3 pph nano alumina particles

F: Comparative roll without filler

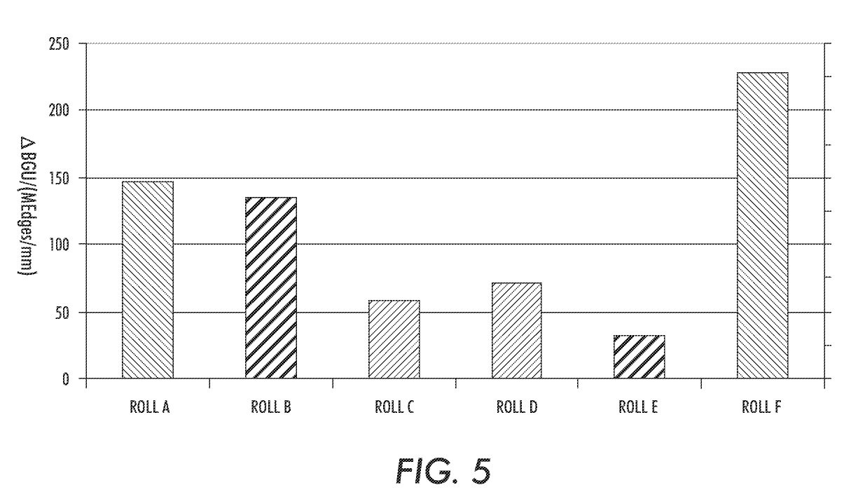

Edgewear (ABGU) is a measure of the difference in gloss on a black print formed with the coated roll between the paper edge (corresponding to the worn area of the roll) and somewhere outside that area. FIG. 5 shows edgewear results for the exemplary material, formed as above, compared with those for comparative fuser member materials. As can be seen from the graph, there is some variability in results. However, in all cases, the filled rolls perform better, i.e., exhibit lower edgewear, than the unfilled comparative examples.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A fuser member, for fixing a developed image to a copy substrate, comprising:
a substrate;
an outer layer over the substrate comprising a halopolymer and filler particles, wherein said filler particles have a particle size of less than 1 micrometer, a hardness of at least 3 on a Mohs hardness scale, and comprise no more than 3 volume percent of the outer layer.

2. The fuser member according to claim 1, wherein, said filler particles which have a particle size of less than 1 micrometer and a hardness of at least 3 on the Mohs hardness scale comprise no more than 2 volume percent of the outer layer.

3. The fuser member according to claim 2, wherein said filler particles are present in said outer layer in an amount of from 0.1 volume percent to 1.5 volume percent.

4. The fuser member according to claim 2, wherein said filler particles are present in said outer layer in an amount of less than 1.0 volume percent.

5. The fuser member according to claim 1, wherein said filler particles have a particle size of less than 200 nanometers.

6. The fuser member according to claim 5, wherein said filler particles have a particle size of from 5 nanometers to 100 nanometers.

7. The fuser member of claim 1, wherein 90% of said filler particles have an individual particle size of less than 100 nanometers.

8. The fuser member according to claim 1, wherein the halopolymer comprises at least one of a haloelastomer and a thermoplastic halopolymer.

9. The fuser member according to claim 8, wherein said halopolymer includes a haloelastomer which comprises a fluoroelastomer selected from the group consisting of a) copolymers of vinylidenefluoride, hexafluoropropylene, and tetrafluoroethylene, b) terpolymers of vinylidenefluoride, hexafluoropropylene, and tetrafluoroethylene, c) tetrapolymers of vinylidenefluoride, hexafluoropropylene, and tetrafluoroethylene, and a cure site monomer, d) volume granted fluoroelastomers, and combinations thereof.

10. The fuser member according to claim 8, wherein said haloelastomer comprises at least 60 vol. % of said outer layer.

11. The fuser member according to claim 1, wherein said filler particles are selected from the group consisting of aluminum oxide, silica, boron nitride, aluminum nitride, boron carbide, silicon carbides, tungsten carbide, anatase titanium dioxide, rutile titanium dioxide, zinc oxide, diamond, and combinations thereof.

12. The fuser member according to claim 11, wherein said filler particles are primarily aluminum oxide.

13. The fuser member according to claim 1, wherein said outer layer further comprises filler particles having a Mohs hardness of less than 3.

14. The fuser member according to claim 1, further comprising at least one intermediate layer disposed between said substrate and said outer layer.

15. The fuser member according to claim 1, wherein the outer layer defines a surface of the fuser member which, in operation is coated with a liquid release agent.

16. The fuser member according to claim 1, wherein the fuser member is in the form of a cylindrical roll or belt.

17. An image rendering device comprising an image applying component for applying an image to a copy substrate and a fusing apparatus for fixing the applied image to a copy substrate, the fusing apparatus including the fuser member of claim 1.

18. An image forming apparatus for forming images on a recording medium comprising:
a charge-retentive surface to receive an electrostatic latent image thereon; a development component to apply toner to said charge-retentive surface to develop an electrostatic latent image to form a developed image on said charge-retentive surface;
a transfer film component to transfer the developed image from said charge-retentive surface to a copy substrate; and
a fusing component for fusing toner images to a surface of said copy substrate, said fusing component comprising:
a substrate; and thereover
an outer layer comprising a halopolymer and filler particles, wherein said filler particles have a particle size of less than 1 micrometer and a particle hardness of greater than 3 on a Mohs hardness scale, said filler particles comprising no more than 3 volume percent of said outer layer.

19. The image forming apparatus according to claim 18, wherein said filler particles are selected from the group consisting of aluminum oxide, silica, boron nitride, aluminum nitride, boron carbide, silicon carbides, tungsten carbide, anatase titanium dioxide, rutile titanium dioxide, diamond, and combinations thereof.

20. The image forming apparatus according to claim 18, wherein the halopolymer comprises a haloelastomer.

21. An image rendering device comprising:
an image applying component for applying an image to a copy substrate; and
a fusing apparatus which receives the copy substrate with the applied image from the image applying component and fixes the applied image more permanently to the copy substrate, the fusing apparatus comprising a fusing member and a pressure member which define a nip therebetween for receiving the copy substrate therethrough, at least one of the fuser member and the pressure member comprising an outer layer which comprises a matrix material and a filler dispersed therein, wherein said filler particles have a particle size of less than 1 micrometer and a particle hardness of greater than 3 on a Mohs hardness scale, said filler particles comprising no more than 3 volume percent of said outer layer.

22. The image rendering device of claim 21, wherein the image applying component is a xerographic image applying component comprising a charge-retentive surface to receive an electrostatic latent image thereon, a development component to apply toner to the charge-retentive surface to develop an electrostatic latent image, and a transfer component to transfer the developed toner image from the charge-retentive surface to a copy substrate.

23. The image rendering device of claim 21, wherein the fusing apparatus includes a heater which heats the outer surface.

24. A method of forming a fusing member comprising:
providing a substrate;
forming an outer layer over the substrate, the outer layer comprising a halopolymer and filler particles, wherein said filler particles have a particle size of less than 1 micrometer and a particle hardness of greater than 3 on a Mohs hardness scale, said filler particles comprising no more than 3 volume percent of said outer layer.

25. The method of claim 24, wherein the forming of the outer layer comprises applying a coating comprising a matrix material and the filler particles to the substrate or to an intermediate layer formed on the substrate.
